(19) United States
(12) Patent Application Publication
(10) Pub. No.: US 2022/0145619 A1
(43) Pub. Date: May 12, 2022

(54) CONCRETE WALL FRAME ASSEMBLY AND METHOD OF MANUFACTURING SAME

(71) Applicant: Nelson Stud Welding, Inc., Elyria, OH (US)

(72) Inventors: Clark CHAMPNEY, Wakeman, OH (US); Bill Houston, Avon, OH (US); Steve D. Brooks, Valley City, OH (US)

(21) Appl. No.: 17/520,973

(22) Filed: Nov. 8, 2021

Related U.S. Application Data
(60) Provisional application No. 63/110,588, filed on Nov. 6, 2020.
(60) Provisional application No. 63/167,160, filed on Mar. 29, 2021.

(51) Int. Cl. E04B 2/40; E04B 2/84

(52) U.S. Cl. CPC E04B 2/40; E04B 2002/0206; E04B 2/84

(57) ABSTRACT

A concrete wall frame assembly and a method of manufacturing same is disclosed. The assembly includes two generally parallel metal plates and at least one rod extending between a first end and a second end. A first end of the rod is passed through a hole in the second plate toward the first plate until the first end engages a continuous inner surface of the first plate. The second end of the rod protrudes through the hole and extends past an outer surface of the second plate. A stud welder is connected to the either the second, protruding end of the rod, or connected to the rod between the two metal plates to stud weld the first rod end to the inner surface of the first plate. The second end of the rod is then arc welded to the second metal plate at the outer surface.

### CROSS REFERENCE TO RELATED APPLICATIONS

This utility patent application is related to and claims the priority of U.S. Provisional Application Ser. No. 63/110,588 filed on Nov. 6, 2020 as well as U.S. Provisional Application Ser. No. 63/167,160 filed on Mar. 29, 2021, the entire disclosures of which are incorporated herein by reference.

### BACKGROUND OF THE INVENTION

The present invention relates to building construction by use of concrete filled frame walls. Certain walls of buildings may be constructed by first constructing a frame comprising two generally parallel metal walls connected by metal rods to form a Concrete Wall Frame (CWF) assembly. Concrete is then poured into the CWF assemblies between the metal walls to create a composite wall sometimes referred to in the industry as Concrete Filled Shear Walls (CFSW) or Concrete Plate Shear Walls (CPSW). The process of constructing such a wall conventionally includes connecting both ends of the rods to respective ones of the metal plates by arc welding.

More specifically, conventional methods of constructing CWFs include positioning two metal plates generally parallel to each other, extending metal rods between the two plates, and welding the rods to the plates by arc welding both ends of the rods. In order to facilitate the structural integrity of this arc welding, each of the two metal plates define a plurality of holes such that the metal rods are extended through a pair of holes disposed in aligned relationship with one another on the two opposing metal plates. Put another way, a first end of the metal rod is extended through one of the holes on a first one of the metal plates and a second end of the metal rod is extended through one of the holes on a second one of the metal plates.

Once the first end of the metal rod is extended through the respective hole on the first metal plate, an arc weld is formed to secure the first end of the rod to the first metal plate. Similarly, once the second end of the rod is passed through the second metal plate, another arc weld is formed, from an outer surface of the second metal plate, to secure the second end of the rod to the second metal plate. As will be appreciated in view of the above mentioned disclosure, the rod length needs to be long enough to span the distance between the two plates, go through the holes in both plates, and protrude out of both plates far enough for the arc welds to be formed on both exterior sides of the metal plates to secure both rods to the metal plates via arc welding.

While Concrete Filled Shear Walls (CF SW) have been proven to have significant advantages with respect to resisting seismic loads and increasing the speed of construction over previously existing methods that relied on steel beams or reinforced concrete, construction of CWFs by arc welding both ends of the rod can still be labor intensive, time consuming and have certain product drawbacks, including a resulting CWF with the rod ends protruding out of the outer surfaces of both metal plates, which can be restrictive and problematic in certain applications. Thus, a continuing need remains in the industry for improved CWF assemblies and methods of manufacturing same for use in forming the CFSWs.

### SUMMARY OF THE INVENTION

The present invention is generally directed to a concrete wall frame (CWF) assembly and a method of manufacturing same, in which a first end of the rod is stud welded, as opposed to arc welded, to a respective one of the metal plates. More specifically, the concrete wall frame assembly includes a first (e.g., lower) metal plate and a second (e.g., upper) metal plate disposed in generally parallel and spaced relationship with one another. Similar to the prior art, the second upper metal plate defines a plurality of holes disposed in spaced relationship with one another and each extending from an outer upper surface to an inner upper surface of the second upper metal plate. However, unlike the prior art, the first lower metal plate does not include any holes and instead presents both an inner and outer lower surface that is continuous, and generally flat and smooth.

At least one rod extends between the first and second metal plates, passing through one of the holes defined by the second metal plate to dispose a first end of the rod in abutting and adjacent relationship with the inner surface of the first metal plate that lacks the holes. A second end of the rod protrudes through the respective hole and extends past the outer upper surface of the second metal plate. A stud welding gun assembly is operably connected to the rod for stud welding the first end of the rod to the inner lower surface of the first metal plate. In accordance with a first embodiment of a method of manufacturing the concrete wall frame assembly, the stud welding gun assembly is operably connected to the second protruding end of the rod to establish the stud weld between the first end of the rod and the first metal plate. In accordance with a second embodiment of the method of manufacturing, the stud welding gun assembly is operably connected to the rod along a portion extending between the first and second metal plates to establish the stud weld of the first end of the rod to the first metal plate. In either embodiment, after the first end of the rod is stud welded, the second end of the rod (which extends through one of the holes and protrudes outwardly from the outer upper surface) is arc welded to the second metal plate. Although not expressly illustrated in the corresponding Figures, after the arc welding process is complete, the protruding second end of the rod could be shortened, such as via chiseling, snipping, or burning off, to place the second end of the rod in essentially flush relationship with the outer upper surface of the second metal plate. However, this process is an optional step to complete construction of the CWF assembly, and utilized in a scenario in which implementation of the CWF assembly requires that both the outer lower surface of the first plate and the outer upper surface of the second plate must be continuous, and generally flat and smooth, for example in view of space limitations.

To facilitate stud welding of the first end of the rod to the inner lower surface of the first metal plate, as outlined above, the subject method of manufacturing the CWF assembly also includes placing a ferrule around the first end of the rod prior to being disposed in abutting relationship with the first metal plate, and placing an insulating member around the second end of the rod to prevent electrical contact between the second end of the rod and the respective hole of the second metal plate through which the second end of the rod passes during the stud welding operation. In other words, the insulating member is arranged adjacent to the second end of the rod prior to the stud welding operation for insulating the rod from the second metal plate. A welding plunge spacer is then used to set a plunge distance for use in the stud welding operation. If the stud welding gun assembly is operably connected to the second protruding end of the rod, the welding plunge spacer is placed between and in sandwiched relationship with the stud welding gun assembly and an outer upper surface of the second metal plate. If the stud welding gun assembly is operably connected to the portion of the rod extending between the two metal plates, and thus the stud welding operation is performed from between the two metal plates, the welding plunge spacer is placed between and in sandwiched relationship with the ferrule and the inner surface of the first lower metal plate. In either arrangement, the welding plunge spacer is used while the stud welding gun assembly is operably secured to the rod such that the rod is unable to move relative to the stud welding gun assembly, and then the welding plunge spacer is removed. Pressure is now applied to the stud welding gun assembly to take up the plunge distance set by the welding plunge spacer to compress a main spring of the stud welding gun assembly. After pressure has been applied to compress the stud welding gun assembly towards a respective one of the metal plates to take up the plunge distance, a trigger on the stud welding gun assembly can be depressed to start and complete the stud welding cycle for securing the first end of the rod to the first metal plate via the stud welding process. The insulating member is then removed from the second end of the rod, followed by the arc welding of the second end of the rod to the second metal plate. This process is completed for all of the rods extending between the first and second metal plates to manufacture a concrete wall frame assembly in accordance with the subject invention.

As will be appreciated in view of the following more detailed disclosure, the method of manufacturing the CWF assembly via stud welding the first end of the rod reduces required construction labor and time over prior art methods which require arc welding both ends of the rod to the respective first and second metal plates. For example, stud welding equipment is lighter and more maneuverable than arc welding equipment, while also providing a faster welding process. When the stud welding operation is performed between the first and second metal plates, the subject method consolidates manufacturing steps, namely because the operator performing the stud welding can also inspect the resultant weld immediately thereafter, particularly when a side-gripping stud welding gun assembly is utilized and the stud welding process is performed from between the first and second metal plates. In addition to saving time over arc welding, stud welding one end of the rod to the inner lower surface of the first metal plate which lacks holes and presents a continuous outer lower surface provides additional benefits. For example, stud welding the first end of the rod eliminates the requirement to have a specific floor gap under the first metal panel to control a protruding rod length, which otherwise would be present to facilitate arc welding of the first end of the rod to an outer lower surface of the first metal plate. Relatedly, both the arc weld and the stud weld can be made from the same side of the first and second metal plates, eliminating the need to lift and turn the plates over during the CWF manufacturing process to complete arc welding from an outer surface of both metal plates. This speeds production by eliminating scheduling and handling delays associated with the need to turn the plates over to have access to the other ends of the rods projecting through the other metal plate.

Stud welding of one rod end eliminates the necessity to install enough diagonal braces to hold the two plates together while the CWF is being lifted and turned during production. In addition, a length of the metal rods can be reduced by a length of the thickness of the plate and about ¾ of an inch extension past an outer lower surface of the first metal plate when an arc welding process is utilized to secure the first end of the rod to the first metal plate. Such a length reduction provides a significant cost savings over a large volume of rods when manufacturing a plurality of CWF assemblies.

Stud welding produces at least one external side of the panels that is flat and smooth (i.e., the rods do not extend past an outer wall surface), providing a CWF assembly with a smaller footprint and use in applications where rods extending from both sides is problematic and undesirable. Relatedly, the subject method of manufacturing the CWF assembly eliminates the need to drill or manufacture holes in the first metal plate to which the first end of the rod is stud welded, further reducing manufacturing steps and related costs.

These and other advantages will be appreciated in view of the following more detailed disclosure.

### BRIEF DESCRIPTION OF THE DRAWINGS

The invention, together with further objects and advantages, may best be understood by reference to the following description taken in conjunction with the accompanying Figures in which like reference numerals identify like elements, and in which:

FIG. 1 is a perspective view of a concrete wall frame (CWF) assembly constructed in accordance with the present invention in which a first end of each rod is stud welded to an inner lower surface of a first metal plate and a second end of each rod is arc welded to an outer upper surface of a second metal plate;

FIG. 1B is a side view of the concrete wall frame assembly of FIG. 1;

FIG. 2A is a partial side view of a pre-assembled concrete wall frame illustrating a method of manufacturing the CWF assembly in which the first and the second metal plates are disposed in generally parallel spaced relationship with one another and the second end of the rod is inserted up from between the first and second metal plates and through one of the holes prior to the stud welding operation;

FIG. 2B is a partial side view of a pre-assembled concrete wall frame illustrating a method of manufacturing the CWF assembly in which the second end of the rod includes a capped insulating sleeve and is inserted up from between the first and second metal plates and through one of the holes prior to the stud welding operation;

FIG. 3 is a partial side view of a pre-assembled concrete wall frame continuing to illustrate the method of manufacturing the CWF assembly in which the first end of the rod is alternatively inserted down through the respective hole from the outer upper surface of the second metal plate prior to the stud welding operation;

FIG. 4 is a partial side view of a pre-assembled concrete wall frame continuing to illustrate the method of manufacturing the CWF assembly in which the first end of the rod is placed adjacent the inner lower surface of the first metal plate and within a ferrule, the second end of the rod protrudes outwardly from the outer upper surface of the second metal plate, and a top or end-gripping stud welding gun assembly is positioned adjacent the second protruding end of the rod before operably engaging the second end of the rod to perform the stud welding operation;

FIG. 5 is a partial side view of a pre-assembled concrete wall frame continuing to illustrate the method of manufacturing the CWF assembly in which the top or end gripping stud welding gun assembly is operably connected with second end of the rod to perform a stud welding of the first end of the rod to the inner lower surface of the first metal plate;

FIG. 6 is a partial side view of a pre-assembled concrete wall frame continuing to illustrate the method of manufacturing the CWF assembly in which the first end of the rod is stud welded to the inner lower surface of the first metal plate, the ferrule is disposed in surrounding relationship with the stud weld, and the un-welded second end protrudes outwardly from the outer upper surface of the second metal plate;

FIG. 7 is a partial side view of a pre-assembled concrete wall frame continuing to illustrate the method of manufacturing the CWF assembly in which the ferrule is removed from the first end of the rod and an insulating member is removed from the second end of the rod after the stud welding operation and prior to arc welding the second end of the rod to the outer upper surface of the second metal plate;

FIG. 8A is a partial side view of the concrete wall frame assembly after the second end of the rod is arc welded to the outer upper surface of the second metal plate;

FIG. 8B is a magnified view of a portion of FIG. 8A more clearly illustrated the second end of the rod arc welded to the outer upper surface of the second metal plate;

FIG. 9 is a partial top view of the second metal plate of a pre-assembled concrete wall frame illustrating one of the holes in the second metal plate and the insulator member comprised of an insulating bushing for insertion into the hole and around the second protruding end of the rod prior to the stud welding operation;

FIG. 10 illustrates the insulating bushing arranged around a portion of the rod adjacent the second end and including an expansion slit extending from a flange and through a cylindrical sleeve portion for allowing the insulating bushing to expand in the radial direction for accommodating a diameter of the rod;

FIG. 11 is a side view of a chuck assembly of the top or end gripping stud welding gun assembly including a stationary jaw and a pivotable jaw pivotably connected to the stationary jaw;

FIG. 12A is a side view of the chuck assembly illustrating an electrical isolator arranged on the stationary jaw and the pivotable jaw of the chuck assembly for isolating electric flow during a stud welding operation;

FIG. 12B is a side view of the chuck assembly illustrating the chuck assembly clamped to the second end of the rod and the stationary jaw defining a concave structure for nesting the rod and aligning the rod along a welding axis of the stud welding gun assembly;

FIG. 13 is a partial perspective view of the top or end gripping stud welding gun assembly operably connected to the second end of the rod and including a welding plunge spacer placed between the top or end gripping stud welding gun assembly and the second metal plate to set a plunge distance for the stud welding operation;

FIG. 14 is a magnified portion of FIG. 13 more clearly illustrating the welding plunge spacer disposed between the top or end gripping stud welding gun assembly and the second metal plate prior to the stud welding operation;

FIG. 15 is a side view of a side-gripping stud welding gun assembly for use in an alternative method of manufacturing the CWF assembly;

FIG. 16 is a perspective view of the side-gripping stud gun welding assembly illustrating a welding plunge spacer disposed between the side-gripping stud welding gun assembly and the inner lower surface of the lower metal plate, and the rod disposed and operably secured in a pair of side-gripping chucks;

FIG. 17 is a top perspective view of the side-gripping stud gun welding assembly disposed between the first and second metal plates prior to a stud welding operation and illustrating a second end of the bar passing through one of the plurality of holes in the second metal plate and including an insulating sleeve;

FIG. 18 is a perspective view of a portion of the first end of the rod illustrating the ceramic ferrule disposed around the first end of the rod and the welding plunge spacer disposed between the ceramic ferrule and the inner surface of the lower metal plate prior to the stud welding operation using the side-gripping stud welding gun assembly;

FIG. 19 is a side view of a portion of FIG. 18 illustrating the rod disposed in a slot of the welding plunge spacer and the first end of the rod passing through a cavity defined by the ferrule;

FIG. 20A is a perspective view of the insulating sleeve; and

FIG. 20B is a perspective view illustrating the insulating sleeve disposed in surrounding relationship with a portion of the rod adjacent the second end.

### DETAILED DESCRIPTION OF THE PREFERRED EMBODIMENTS

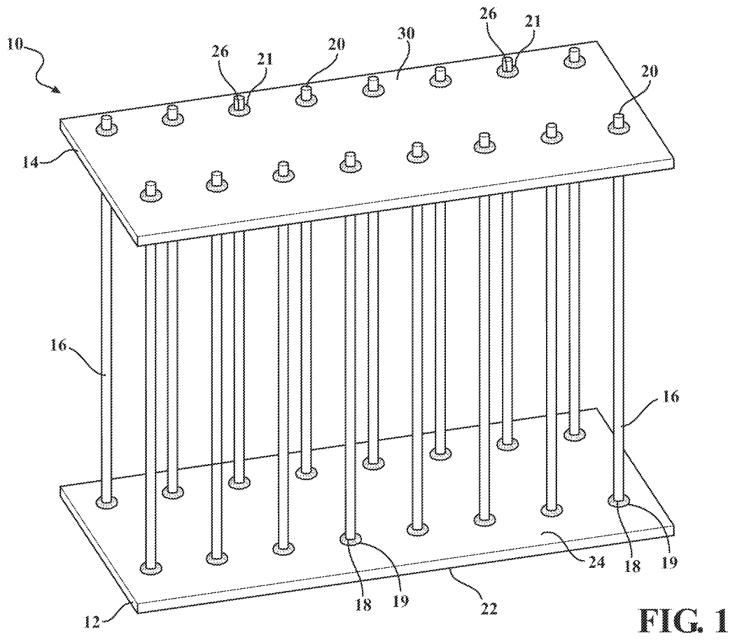

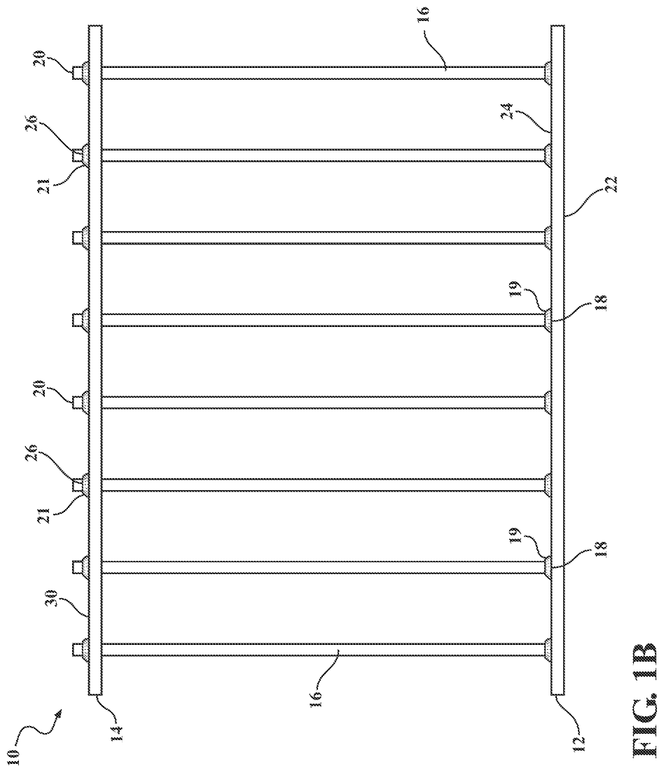

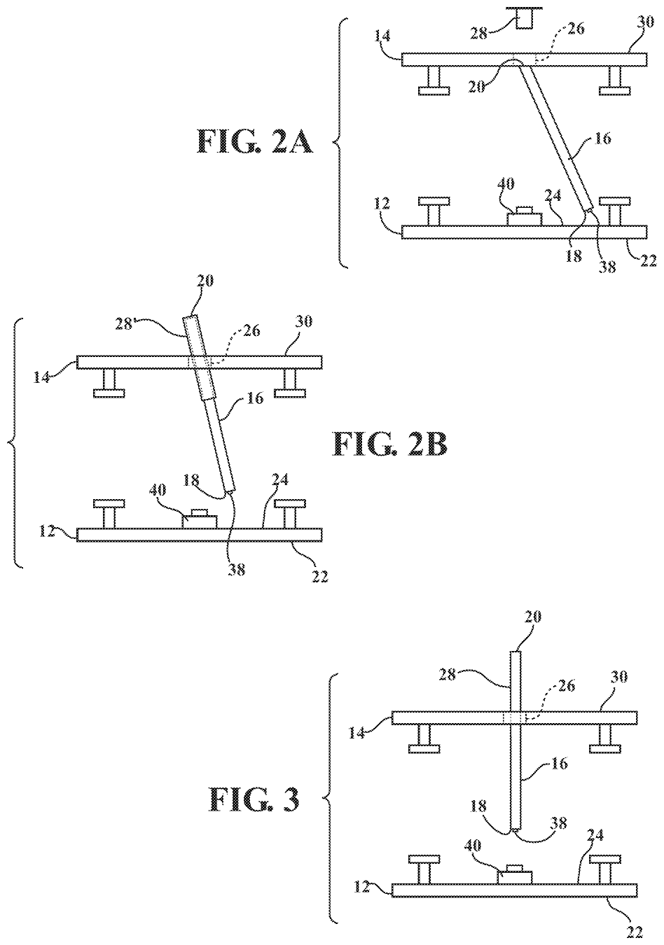

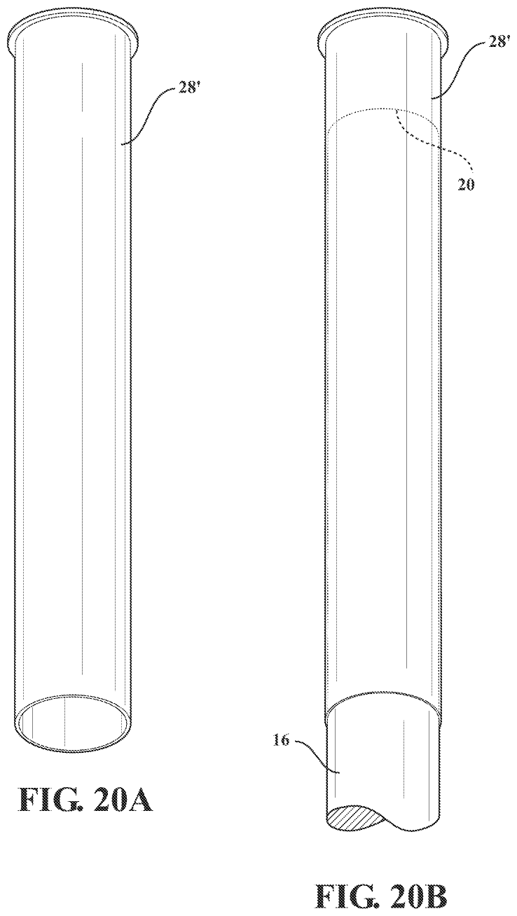

FIGS. 1 and 1B illustrate a concrete wall frame (CWF) assembly 10 constructed in accordance with the principles of the present invention. The CWF assembly 10 includes a first metal plate 12 positioned generally parallel to a second metal plate 14. In the remaining disclosure, the first metal plate 12 is referred to as a lower metal plate and the second metal plate 14 is referred to as an upper metal plate. However, the lower and upper plates could be switched or disposed in alternative arrangements (e.g., both side plates) without departing from the scope of the subject disclosure. The first and second metal plates 12, 14 are connected to one another via one or more rods 16 extending between the first and second metal plates 12, 14. Each rod 16 extends between a first end 18 connected to the first metal plate via a stud weld 19 and a second end 20 extending into holes 26 through the second metal plate 14 and connected to the second metal plate 14 via an arc weld 21. The first metal plate 12 includes no openings to present a continuous outer lower surface 22 and a continuous inner lower surface 24. As best illustrated in FIGS. 1, 11 and 17, the second upper metal plate 14 defines a plurality of holes 26 each of which is sized to receive the second end 20 of the rod 16 therethrough. Preferably, the holes 26 are ¼″ larger in diameter than a diameter of the rods 16 passing therethrough for allowing the rods 16 to be easily installed and provide clearance for an insulating member 28, 28′, such as an insulating bushing 28 (See FIGS. 2A, 7 and 9-10) or an insulating sleeves 28′ (See FIGS. 2B, 20A, and 20B), each described in more detail below, for electrically isolating the rods 16 from the second upper metal plate 14 during a stud welding operation that is performed to secure the first end 18 of the rod 16 to the first lower metal plate 12. The second end 20 of each rod 16 extends axially to or past an outer upper surface 30 of the second upper metal plate 14. Referring to the various Figures, a method for connecting the first end 18 of the rod 16 to the first lower metal plate 12 via stud welding and the second end 20 of the rod 16 to the second upper metal plate 14 via arc welding will now be described in more detail.

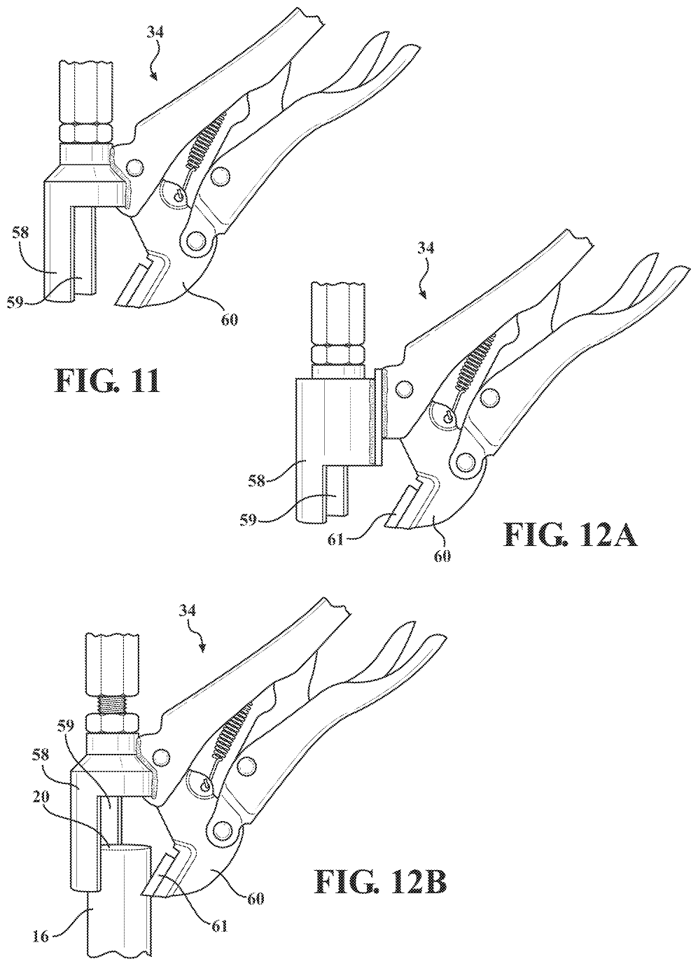

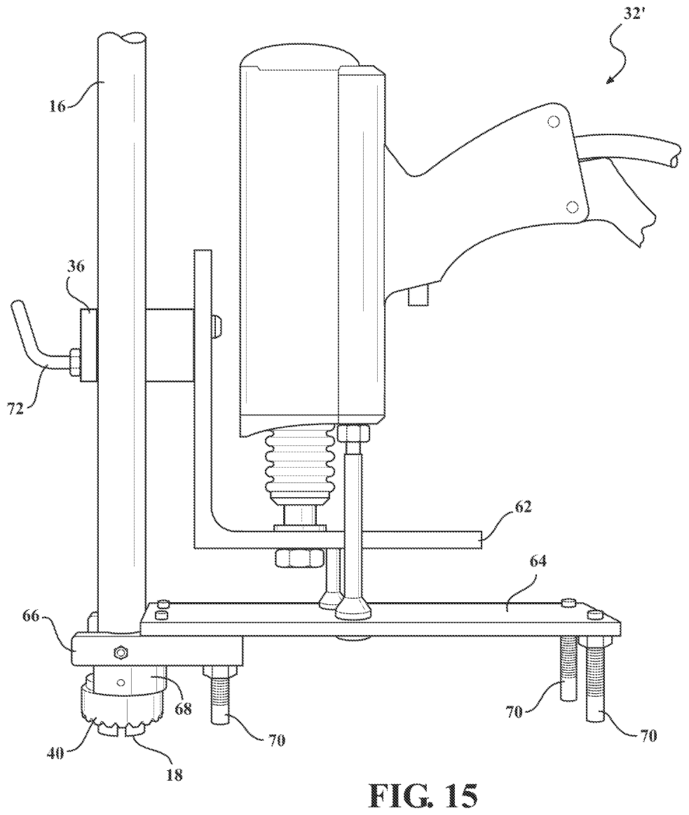

As mentioned previously, and unlike the prior art CWF assemblies, the subject CWF assembly 10 includes the first end 18 of the rod 16 connected to the first lower metal plate 12 via a stud weld 19. In accordance with a first embodiment of a method of manufacturing the CWF assembly 10, a top or end-gripping stud welding gun assembly 32 is operably connected to the second end 20 of the rod 16 which protrudes outwardly from the outer upper surface 30 of the second metal plate 14 to establish the stud weld 19 between the first end 18 of the rod 16 and the first lower metal plate 12. As will be discussed in greater detail below in reference to FIGS. 11-14, the top or end-gripping stud welding gun assembly 32 can include a chuck assembly 34 to clamp the second end 20 of the rod 16 to establish the operable connection between the rod 16 and the top or end-gripping stud welding gun assembly 32 for use in stud welding the first end 18 of the rod 16. However, as illustrated in FIGS. 15-17, in accordance with a second embodiment of the method of manufacturing the CWF assembly 10, a side-gripping stud welding gun assembly 32′ is operably connected to the rod 16 along a portion of the rod 16 extending between the first and second metal plates 12, 14 with the side-gripping stud welding gun assembly 32′ having at least one side gripping chuck 36 for gripping the rod 16 from the side, and securing the rod 16 to the stud welding gun assembly 32′ during stud welding of the first end 18 of the rod 16 to the first lower metal plate 12. In either embodiment, after the first rod end 18 is stud welded, the second end 20 of the rod 16 passing through the hole 26 in the second upper metal plate 14 is arc welded to the second upper metal plate 14 at the outer upper surface 30 to complete construction of the CWF assembly 10.

In the method of stud welding the first end 18 of the rod 16 to the first lower metal plate 12, as best illustrated in FIGS. 2A and 2B, the second end 20 of the rod 16 may be inserted up from between the first and second metal plates 12, 14 through one of holes 26. Alternatively, as best illustrated in FIG. 3, the first end 18 of the rod 16 can be inserted down through the hole 26 from an outer upper surface 30 of the second upper metal plate 14. As best illustrated in FIG. 3, in either process of locating the rod 16 relative to the metal plates 12, 14 and the respective hole 26, the first end 18 of the rod 16 includes flux 38 having the flux load needed for the stud welding process thereon. After being passed through the hole 26, the first end 18 of the rod 16 may then be lowered into a bore of a ceramic ferrule 40 that is also needed for the stud welding process. A length of the rod 16 is such that the overall length of the rod 16 will allow the second end 20 of the rod 16 to extend out of the hole 26 in the second upper metal plate 14 by a certain distance, such as approximately equal to the diameter of rod 16.

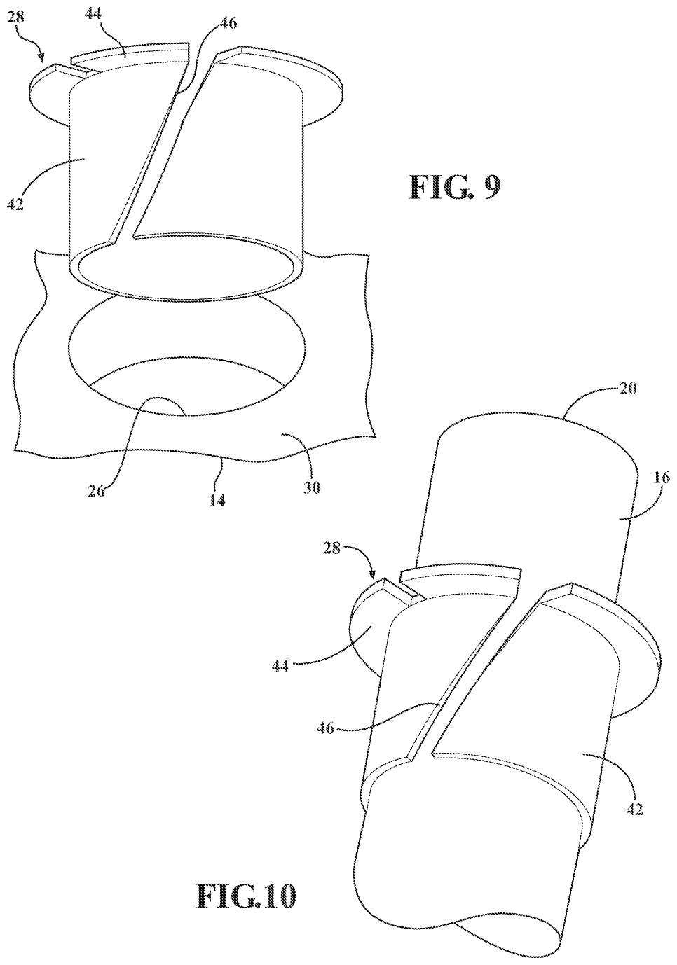

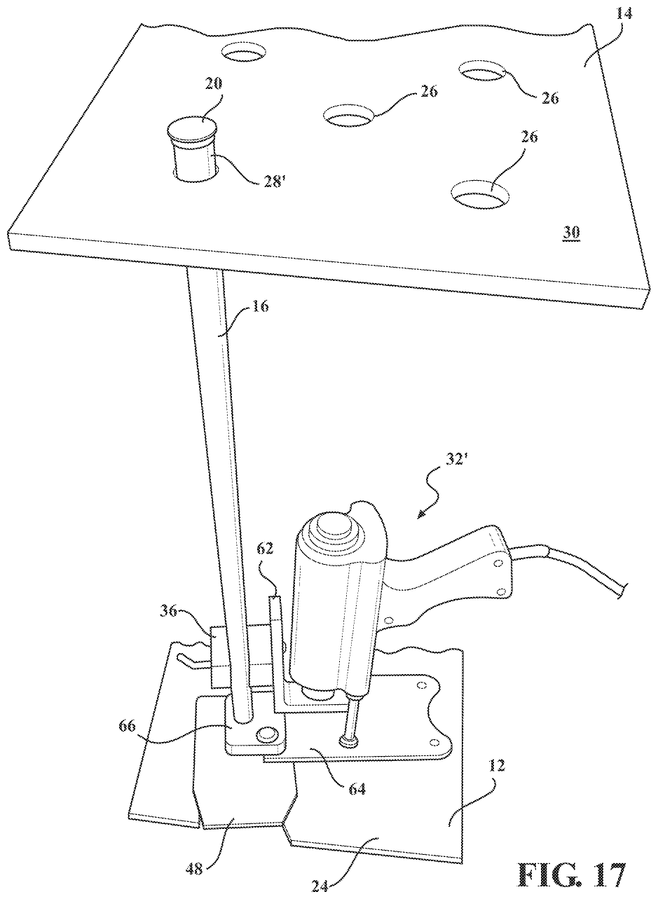

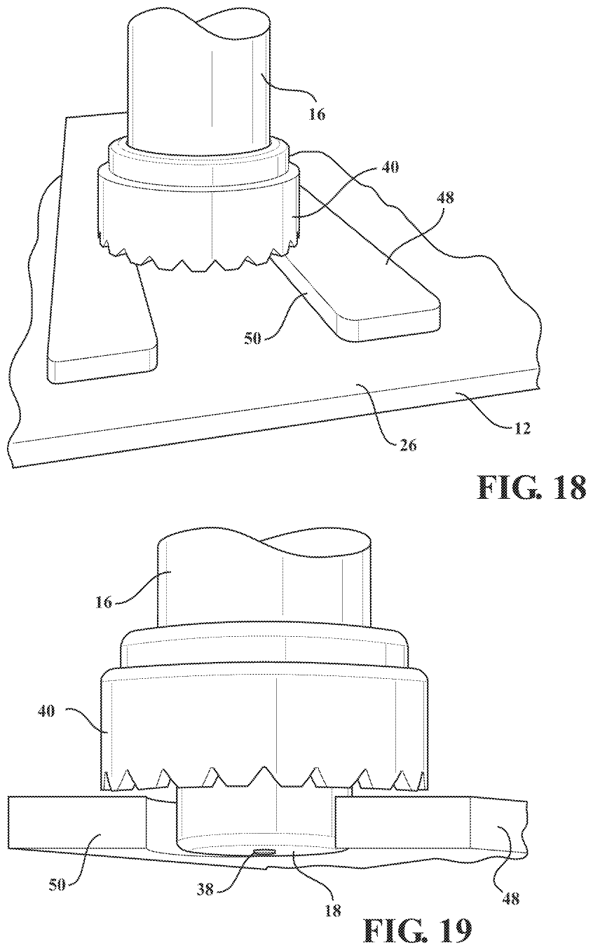

To prevent weld current from passing between the rod 16 and the second upper metal plate 14 during the stud welding operation, an insulating member 28, 28′ is arranged on the second end 20 of the rod 16 prior to the stud welding operation for insulating the rod 16 from the second upper metal plate 14. For example, the insulating member 28, 28′ can include an insulating bushing 28 or a capped insulating sleeve 28′ each made from a nonconductive insulating material (e.g., plastic or the like) that is inserted into the hole 26 in the second upper metal plate 14 or around the rod 16 adjacent the second end 20. (See, e.g., FIGS. 9-10, 17 and 20). For example, FIG. 9 shows a portion of a hole 26 in the second upper metal plate 14 of the concrete wall frame assembly 10 for receiving the insulating bushing 28. As best shown in FIGS. 9-10, the insulating bushing 28 includes a cylindrical sleeve portion 42 for closely/snugly surrounding a portion of the rod 16 disposed adjacent the second end 20. The insulating bushing 28 also includes a flange 44 which extends radially outwardly from the sleeve portion 42 and is disposed in abutting and overlaying relationship with the outer upper surface 30 of the second upper metal plate 14 when the insulating bushing 28 is disposed in the hole 26 and around the rod 16 for insulating the rod 16 from the second upper metal plate 14. The insulating bushing 28 also includes an expansion slit 46 extending from the flange 44 and through the cylindrical sleeve portion 44 at which the insulator bushing 28 may separate and expand in the radial direction to allow the insulator bushing 28 to accommodate different sized rods 16 having varying diameters. The cylindrical sleeve portion 42 of the insulating bushing 28 may be inserted into the hole 26 and the flange 44 serves as a stop for mating with the outer upper surface 30 to ensure that the insulator bushing 28 is seated between the rod 16 and the second upper metal plate 14. In an alternative arrangement, the insulating member 28, 28′ is comprised of a capped insulating sleeve 28′ that is placed in surrounding relationship with a portion of the rod 16 disposed adjacent the second end 20, such as illustrated in FIGS. 17 and 20. The insulating sleeve 28′ extends along a longer portion of the rod 16, as compared to the insulating bushing 28, to insure that the rods 16 are not pushed so far through the holes 26 in the second upper metal plate 14 during the installation process such that isolation of the rods 16 from the second upper metal plate 14 is no longer present, namely because electrical contact between the bar 16 and the hole 26 in the second upper metal plate 14 would preclude making an acceptable stud weld. Additionally, the longer length of the capped insulating sleeve 28′ prevents a lower end of the insulating sleeve 28′ from passing through the hole 26 during a lift of the rod 16 in the stud welding operation, which avoids the insulating sleeve 28′ from being caught on the hole 26 which would prevent the insulating sleeve 28′ from passing back through the hole 26 during the plunge in the stud welding operation. FIG. 18 of U.S. Provisional Application Ser. Nos. 63/110,558 and 63/167,160, the disclosures of which are incorporated herein by reference, provide a more detailed description of the “plunge” and the “lift” in the stud welding operation.

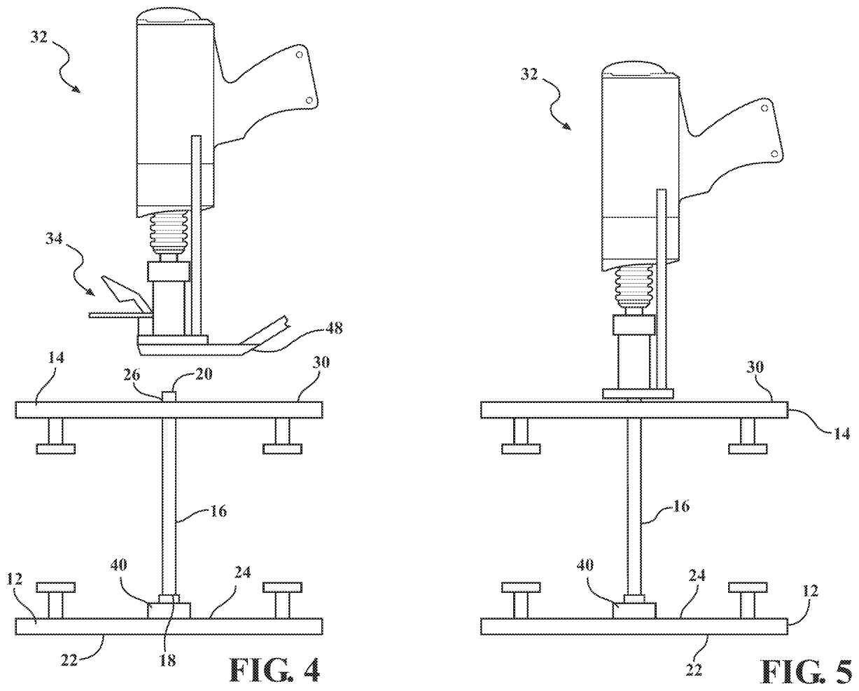

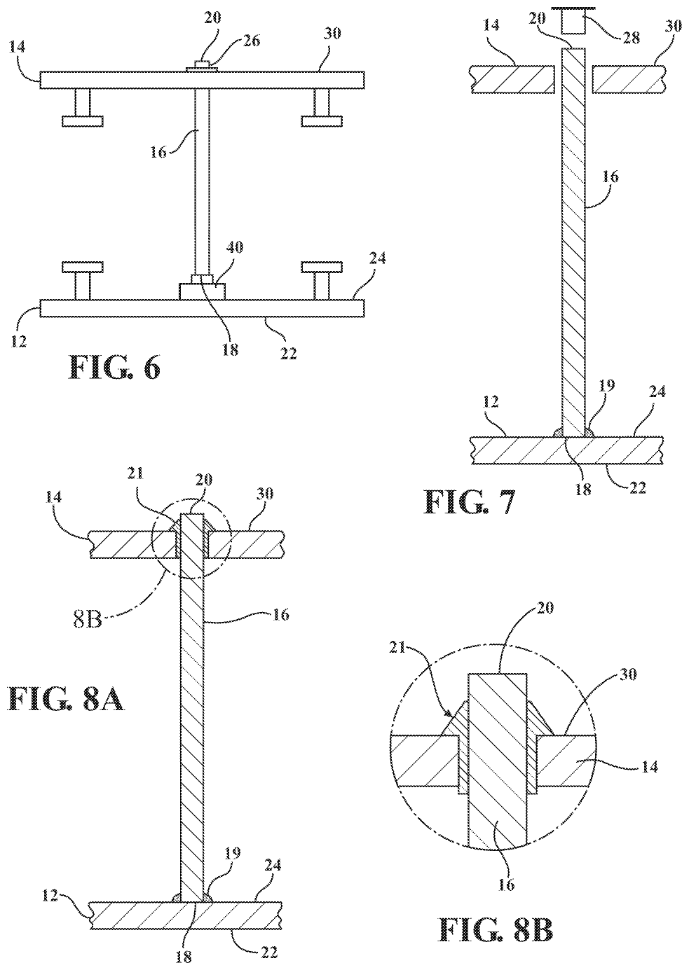

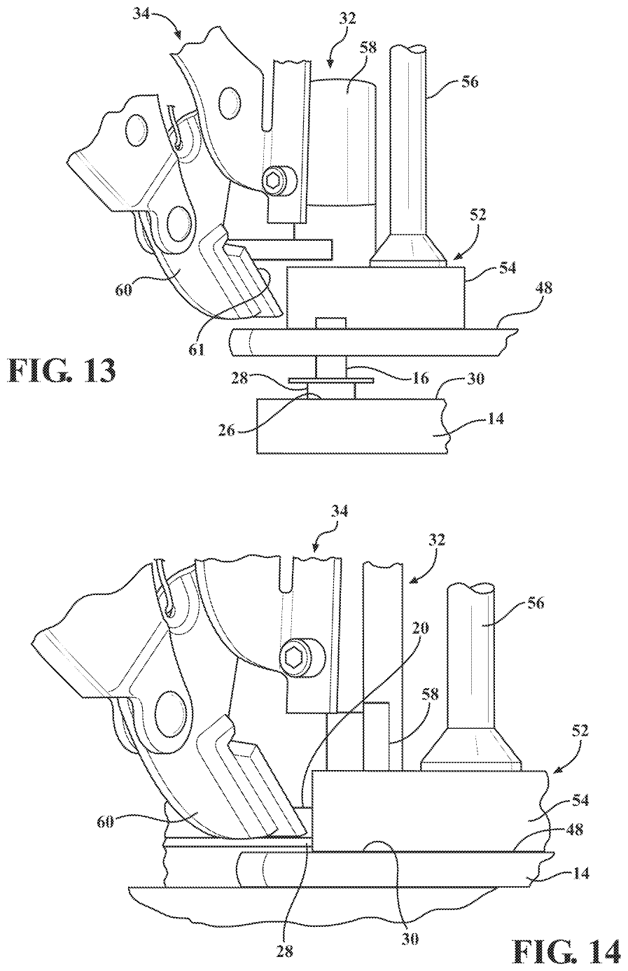

To facilitate stud welding of the first end 18 of the rod 16 to the inner lower surface 24 of the first lower metal plate 12, the ceramic ferrule 40 is placed around the first end 18 of the rod 16 prior to being disposed in abutting relationship with the inner lower surface 24. A welding plunge spacer or shim 48 is then used to set a plunge distance for use in the stud welding operation. With reference to FIG. 18 of U.S. Provisional Application Ser. Nos. 63/110,558 and 63/167,160, the disclosures of which are incorporated herein by reference, the plunge distance is an amount of the rod 16 which protrudes beyond the ferrule 40 and the portion of the rod length that is available to be “burned off” or melted to develop the weld flash during a stud welding operation. If the top or end-gripping stud welding gun assembly 32 is operably connected to the second protruding end 20 of the rod 16, such as shown in FIGS. 4-5, the welding plunge spacer 48 is placed between and in sandwiched relationship with the top or end-gripping stud welding gun assembly 32 and the outer upper surface 30 of the second upper metal plate 14. (See, e.g., FIGS. 13-14). If the side-gripping stud welding gun assembly 32′ is used and operably connected to the portion of the rod 16 extending between the first and second metal plates 12, 14, such as illustrated in FIGS. 15-17, the welding plunge spacer 48 is placed between and in sandwiched relationship with the ferrule 40 and the inner lower surface 24 of the first lower metal plate 12. (See e.g., FIGS. 17-19). In either arrangement, the welding plunge spacer 48 can include a slot 50 for allowing the welding plunge spacer 48 to be slid into and placed in abutting relationship with the rod 16. A thickness of the welding plunge spacer 48 is equal to a desired plunge allowance (i.e., the plunge distance) in the subsequent stud welding operation. For example, if the rod 16 to be stud welded has a one inch diameter, a thickness of the welding plunge spacer 48 is preferably equal to 5/16″ (made up of ¼ inch of burn-off plus 1/16″ of load/flux 38 projecting from the first end 18 of the rod 16). If the rod 16 to be stud welded has a ¾″ diameter, a thickness of the welding plunge spacer 48 is preferably ¼″ (made up of 3/16 inch of burn-off plus 1/16″ of load/flux 38). And, if the rod 16 to be stud welded has a ½ inch diameter, the thickness of the welding plunge spacer 48 is preferably 3/16″ (made up of ⅛″ burn-off plus 1/16″ load/flux 38).

In any arrangement, once the welding plunge spacer 48 is set in place, the stud welding gun assembly 32, 32′ is operably secured to the rod 16, such as through use of the chuck assembly 34 on the top or end-gripping stud welding gun assembly 30 or the at least one side-gripping chuck 36 on the side-gripping stud welding gun assembly 32′, and then the welding plunge spacer 48 is removed. As is known in the art, imperfections and tolerances in the metal plates 12, 14, such as plate sag, plate deformation, etc. may cause a distance extending between the plates 12, 14 to vary from rod location to rod location, as defined by the spacing between the plurality of holes 26 in the second upper metal plate 14. However, a typical automatic stud welding system disadvantageously relies on those inconsistent distances to set or preset the automatic rod weld stroke of the process. Specifically, existing stud welding accessories rely on having consistent such distances and rods of consistent length and would not work if there were such inconsistencies. Furthermore, such a conventional stud welding system requires a setting of the plunge distance while a plate is between the gun and the plate to be welded. Use of the welding plunge spacer 48 in the subject process advantageously compensates for or takes these inconsistencies and imperfections into account in order to consistently set the plunge axial stroke of a weld machine in the stud welding gun assembly 32, 32′ from rod to rod so that the weld plunge stroke in the weld process of each of the various rods in welding the concrete wall frame are appropriate regardless of the imperfections and inconsistencies (e.g., plate flatness or spacing dimensions or rod length). Use of the welding plunge spacer 48 consistently provides a system and method for using the stud welding gun assembly 32, 32′ to set the plunge distance while a plate is positioned between the stud weld assembly and another plate to be welded.

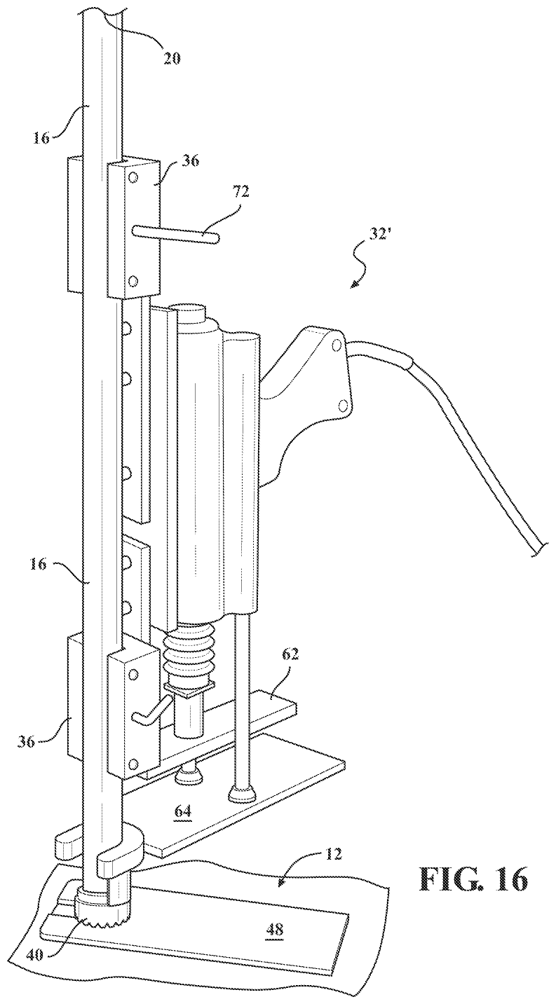

Once the welding plunge spacer 48 is removed, pressure is now applied to the stud welding gun assembly 32, 32′ to take up the plunge distance set by the welding plunge spacer 48 and compress a main spring of the stud welding gun assembly 32, 32′. After pressure has been applied to compress the stud welding gun assembly 32, 32′ towards a respective one of the metal plates 12, 14 to take up the plunge distance and dispose either the stud welding gun assembly 32 into contact and abutting relationship with the outer upper surface 30 of the second upper metal plate 14 (i.e., in the top/end mounted arrangement of the stud welding gun assembly 32), or to dispose the side mounted arrangement of the stud welding gun assembly 32′ into pressed and abutting relationship with the ferrule 40 to press the ferrule 30 into contact with and abutting relationship with the lower inner surface 26 of the first lower metal plate 12, a trigger on the stud welding gun assembly 32, 32′ can be depressed to start and complete the stud welding cycle for securing the first end 18 of the rod 16 to the first lower metal plate 12 via stud welding. FIG. 16 of U.S. Provisional Application Ser. Nos. 63/110,558 and 63/167,160, the disclosures of which are incorporated herein by reference, provide a more detailed description of the sequence of steps for the stud welding operation.

With reference to FIGS. 4-5 and 11-14, in the top or end-mounted arrangement for stud welding the first end 18 of the rod 16 to the first lower metal plate 12, the top or end-gripping stud welding gun assembly 32 can include a chuck assembly 34 for setting the relative positions among the stud welding gun assembly 32, the rod 16, and the first and second metal plates 12, 14. As illustrated in FIGS. 4 and 13-14, the chuck assembly 34 can include a foot assembly 52 for setting a minimum distance between the object to be welded and the stud welding gun assembly 32. The foot assembly 52 includes a foot 54 that is telescopically extendable toward and away from stud welding gun assembly 32 via an elongated leg 56 that slides in a sleeve in the housing or body of stud welding gun assembly 32. A relative distance between the foot 54 and the stud welding gun assembly 32 may be adjusted and then fixed by clamping or threaded engagement between the elongated leg 56 and the stud welding gun assembly 32 to prepare for the welding process. The chuck assembly 34 may include a vise-type clamping structure with a stationary self-centering jaw 58 for centering the rod 16 along a central stroke axis of the stud welding gun assembly 32. The stationary self-centering jaw 58 may define a concave-shaped cavity 59 to aid in self-positioning (e.g., self-centering or self-aligning) the second end 20 of the rod 16 with an axis of the stud welding gun assembly 32. A vise grip type lever arm mechanism, such as a movable jaw 60 is pivotably connected to stationary jaw 58. The movable jaw 60 may be urged by a user to clamp the second end 20 of the rod 16 between the stationary jaw 58 and the pivotable jaw 60. The vise grip type lever arm mechanism could also be an actuatable jaw that is biased (e.g., spring biased) toward the stationary self-centering jaw 58 to secure the second end 20 therebetween by clamping. An electrical insulator 61 may be provided on one or both of the stationary jaw 58 and the pivotable jaw 60 in order to isolate electric flow so that current cannot flow through the pivot mechanism of the chuck assembly 34. Such current flow could cause an undesirable inoperability by weld fusing of the clamp members that were intended to pivot. Isolating that current from portions of the chuck assembly 34 also prevents an operator from being exposed to electricity.

FIG. 12B illustrates the chuck assembly 34 of the top or end-gripping stud welding gun assembly 32 clamped to the rod 16 which is positioned for welding in the concrete wall frame assembly 10. As illustrated in FIG. 13, before or after the second end 20 of the rod 16 is clamped by the chuck assembly 34, and as explained above, the welding plunge spacer 48 with a thickness equal to the desired distance of the axial plunge of the rod 16 is placed between the stud welding gun assembly 32 and the second upper metal plate 14, such as between an outer engagement face of the foot 54 and the outer upper surface 30 of the second upper metal plate 14. The foot assembly 52 of the stud welding gun assembly 32 with foot 54 is then secured or clamped to the rod 16 and relative to stud welding gun assembly 32 and then the welding plunge spacer 48 is removed. The stud welding gun assembly 32 can then be compressed toward the second upper metal plate 14 by the axial distance previously occupied by the thickness of the welding plunge spacer 48 until the stud welding gun assembly 32, such as its foot 54, contacts the outer upper surface 30 of the second upper metal plate 14. The stud welding gun assembly 32 includes a spring memory clutch mechanism which remembers or locks an axial compression distance (i.e., the plunge distance) and is bushingable of reversing same compression distance later. After clamping of rod 16, forcing/compressing or against retracting foot assembly 52 back toward the stud welding gun assembly 32 locks in the axial preload weld plunge distance to be re-extended later during the stud welding operation.

As mentioned above, after the welding plunge spacer 48 has been removed, downward pressure should be applied to the gun handle with one hand then the chuck assembly 34 should be gripped with the other hand and the chuck assembly 34 and the rod 16 should retracted so that the first end 48 of the rod 16 with flux 38 is to be lifted slightly off and away from the first lower metal plate 12. Retracting rod 16 will allow the first end 18 of the rod 16 and the ceramic ferrule 40 (by gravity like a pendulum) to move or swing move into a true perpendicular orientation. Chuck assembly 34 can them be released to allow the rod 16 to again be in contact with the first lower metal plate 12.

The lifting and releasing of the rod 16 will be repeated when the stud welding gun assembly 32 lifts and plunges the rod 16 during the stud welding process. While the rod 16 is being manually retracted care should be taken to not lift the first end 18 of the rod 16 with flux 38 out of the bore of the ceramic ferrule 40. The stroke of the stud welding gun assembly 32 is less that the height of the ceramic ferrule 40. Therefore, the first end 18 of the rod 16 with flux 38 would not be lifted out of the ceramic ferrule 40 if pressure is applied on the handle of the stud welding gun assembly 32 to keep the face of foot 54 in contact with the outer upper surface 30 of second upper metal plate 14.

After the operation of manually retracting and lowering the rod 16, the top or end-gripping stud welding gun assembly 32 can then be triggered to make the stud weld 21 between the first end 18 of the rod 16 and the inner lower surface 24 of the first lower metal plate 12. The ceramic ferrule 40 can be left in place around the welded rod or broken and removed. In many assemblies where multiple tie rods are being welded the space between the rods 16 may prevent removal of the ceramic ferrules 40. When the ceramic ferrule 40 cannot be removed to visually inspect the weld flash, the inspection procedure to determine the quality of the stud welds should consist of inspection of the after weld length of the rods 16. For full penetration welds to be made a reduction in the length of the rod 16 must have taken place. The normal reduction in stud length is equal to one fourth of the diameter of the stud. An electric weld monitor may also be used to record and confirm that the weld current, time, arc resistance and energy in Joules were within the specified range. The weld monitor can be set to show an alarm or shut down making of more welds if a weld is made that is not within the selected limits.

With reference to FIGS. 15-17, in the side-mounted arrangement for stud welding the first end 18 of the rod 16 to the first lower metal plate 12, the side-gripping stud welding gun assembly 32′ includes an angle bracket 62, a bipod foot plate 64, a bipod foot shear connector 66, a ferrule grip shear connector 68 and at least one side-gripping chuck 36 for setting the relative positions among stud welding gun assembly 32, rod 16, and the first and second metal plates 12, 14. The side-gripping stud welding gun assembly 32′ can also include one set of bipod pins 70 connected to the bipod foot plate 64 and one set of bipod pins 70′ connected to the bipod foot shear connector 66 for supporting the stud welding gun assembly 32′ so that it will remain standing in an upright vertical position. According to an embodiment, bipod pins 70 can be replaced by wheels or swivel rollers to facilitate moving the side-gripping gun welding assembly 32′ between the bars 16 and different welding locations.

With the parts and equipment described above, the operator will go between the first and second metal panels 12, 14 and insert the second end 20 of each rod 16 onto which is attached the insulating sleeve 28′, through one of the holes 26 in the second upper metal plate 14. Before allowing the first end 18 of the rod 16 having the flux 38 to contact the lower metal plate 12, the operator places one of the ceramic ferrules 40 on the first lower metal plate 12 with the ferrule 40 defining a cavity to contain the weld against the inner lower surface 24 of the first lower metal plate 14. The first end 18 of the rod 16 can then be lowered into ceramic ferrule 40. The perpendicular alignment of the bar 16 should then be checked to be sure that it is in a position where it can be moved up and down by the side-gripping stud welding gun assembly 32′ without binding.

The method proceeds by lifting the ceramic ferrule 40 off the inner lower surface 24 of the first lower metal plate 12 and placing the welding plunge spacer 48 between the ceramic ferrule 40 and the first lower metal plate 12 until an end of the slot 50 defined by the welding plunge spacer 48 is slid into contact with the bar 16. The ceramic ferrule 40 is then lowered onto a top surface of the welding plunge spacer 48. The side-gripping stud welding gun assembly 32′, as shown in FIGS. 15-17, should now be brought into contact with the rod 16, such that the rod 16 extends through the at least one side-gripping chuck 36. Additionally, the shear connector ferrule grip 68 should be seated and engaged over the ceramic ferrule 40 adjacent the first end 18 of the rod 16. If the at least one side-gripping chuck 36 includes a pair of gripping chucks 36, such as shown in FIG. 16, a portion of the length of the bar 16 should extend between each of the side gripping chucks 36. The rod 16 should be deflected or squeezed back into the side gripping chucks 36 so that the center of the rod 16 goes behind the center of spring loaded ball detents that are disposed in the side gripping chucks 36. After a major diameter of the rod 16 is behind the center of the ball detents, the ball detents will hold the rod 16 back against a slot in the side gripping chucks 36.

After the rod 16 has been aligned and seated in the at least one side gripping chuck 36, and the welding plunge spacer 48 is seated between the ferrule 40 and the inner lower surface 24 of the first lower metal plate 12, the side gripping chuck 36 should be firmly tightened against the bar 16, such as with the use of tightening lever screws 72. The tightening lever screws 72 assure that the bar 16 will be held tightly enough to be lifted the correct plunge distance by the side-gripping stud welding gun assembly 32′ during the stud welding operation. After the tightening screw levers 32 have been tightened against the bar 16, the welding plunge spacer 48 is removed from under the ceramic ferrule 40, with the slot 50 allowing for the welding plunge spacer 48 to be removed, leaving a gap between a lower face of the ceramic ferrule 40 and the inner lower surface 24 of the first lower metal plate 12 equal to the thickness of the welding plunge spacer 48 and the desired plunge distance for use in the stud welding operation. In accordance with the above-mentioned processes, sufficient pressure is then applied to the handle of the side-gripping stud welding gun assembly 32′ to overcome the pressure of the mainspring in the stud welding gun assembly 32′ to bring the ceramic ferrule 40 into contact with the inner lower surface 24 of the first lower metal plate 12. With the stud welding gun assembly 32′ in this compressed condition the trigger of the side-gripping stud welding gun assembly 32′ should be depressed to start the stud welding cycle in accordance with the stud welding principles described above. (See also FIGS. 16 and 18 of U.S. Provisional Application Ser. Nos. 63/110,558 and 63/167,160, the disclosures of which are incorporated herein by reference, providing a more detailed description of the sequence of steps for the stud welding process.)

Once the stud welding process is complete, the tightening screw levers 72 on the at least one side gripping chuck 36 can now be untightened to release the rod 16 from the stud welding gun assembly 32′. The stud welding gun assembly 32′ can then be lifted enough for the bore of the shear connector ferrule grip 68 to be above the neck on the ceramic ferrule 40. After the stud welding assembly 32′ has been elevated, the stud welding gun assembly 32′ can now be pulled laterally with enough force to overcome any holding pressure the ball detents in the side gripping chucks 36 are applying to the bar 16 now securely stud welded to the first lower metal plate 12. This lifting and lateral force will free the stud welding gun assembly 32′ from the bar 16. After the weld operation, the stud welding gun assembly 32′ can then be left standing and supported in a vertical position by the two bipod pins 70 on the shear connector foot 66 and the two bipod pins 70′ on the bipod foot plate 64.

The operator inserting the bars 16 and stud welding them can now break off the ceramic ferrule 40 and visually inspect the weld to see if they have the full 360 degrees of weld flash that is required by the American Welding Society D1.1 Construction Welding Code, Steel. This would complete the stud welding of the first end 18 of the rod 16 to the first lower metal plate 12.

A significant advantage of the side-gripping gun welding assembly 32′ described immediately above is that it reduces processing time by allowing the operator who is stud welding the first ends 18 of the rods 16 to also break off the ceramic ferrules 40 after the stud welds 19 and complete the requisite visual inspection. In the top or end-mounted stud welding gun assembly 32, an operator completing the stud welding process from outside the second upper metal plate 14 must then later crawl between the two metal plates 12, 14 to complete the visual inspection processes. Or alternatively, another operator is required to to complete this visual inspection after the stud welding is complete. Revising the process to accommodate stud welding from between the two metal plates 12, 14 eliminates the time and/or number of operators associated with this process, allowing the stud welding and inspection to be completed at the same time.

After the stud weld 19 has been made between the first end 18 of the rod 16 and the first lower metal plate 12, using either the top-mounted or side mounted stud welding assemblies 32, 32′ described above, the second end 20 of each rod 16 will be projecting out of a respective hole 26 in second upper metal plate 14. The insulating members 28, 28′ around the unwelded second end 20 of the rod 16 can then be removed from the respective holes 26 and an arc welding procedure can then be used to make an arc weld 21 to join the second end 20 of each rod 16 to second upper metal plate 14 to complete the method of manufacturing the CWF assembly 10. (See, e.g., FIG. 8).

As is apparent from the foregoing specification, the invention is susceptible of being embodied with various alterations and modifications which may differ particularly from those that have been described in the preceding specification and description. It should be understood that applicant wishes to embody within the scope of the patent warranted hereon all such modifications as reasonably and properly come within the scope of my contribution to the art.

What is claimed:

1. A concrete wall frame assembly comprising:
a first metal plate and a second metal plate disposed in generally parallel and spaced relationship with one another;
said first metal plate presenting a continuous inner surface;
said second metal plate defining a plurality of holes disposed in spaced relationship with one another and each of said plurality of holes extending from an outer surface through said second metal plate;
at least one rod passing through a respective one of said plurality of holes and extending from a first end disposed in abutting relationship with said continuous inner surface of said first metal plate to a second end disposed in protruding relationship from said outer surface of said second plate;
said second end of said rod arc welded to said outer surface of second metal plate; and
said first end of said rod stud welded to said continuous inner surface of said first metal plate.

2. The concrete wall frame assembly as set forth in claim 1, further comprising:
said at least one rod including a plurality of rods each passing through a respective one of said plurality of holes and each extending from a first end disposed in abutting relationship with said continuous inner surface of said first metal plate to a second end disposed in protruding relationship from said outer surface of said second metal plate;
said second end of each of said plurality of rods arc welded to said outer upper surface of said second metal plate; and
said first end of each of said plurality of rods stud welded to said inner continuous surface of said first metal plate.

3. A method of manufacturing a concrete wall frame assembly comprising:
placing a first metal plate having a continuous inner surface and a second metal plate defining a plurality of holes in generally parallel and spaced relationship with one another;
inserting at least one rod through a respective one of the plurality of holes in the second metal plate to dispose a first end of the rod in abutting relationship with the continuous inner surface of the first metal plate and a second end of the rod in protruding relationship from an outer surface of the second metal plate;
stud welding the first end of the rod to the continuous inner surface of the first metal plate; and
arc welding the second end of the rod to the outer surface of the second metal plate.

4. The method as set forth in claim 3, further comprising:
arranging an insulating member on the second end of the bar to insulate the rod from the second metal plate prior to stud welding the first end of the bar to the continuous inner surface of the first metal plate; and
removing the insulating member from the second end of the bar after said stud welding step and prior to said arc welding step.

5. The method as set forth in claim 4, further comprising:
positioning a ferrule about the first end of the bar prior to disposing the first end of the bar in abutting relationship with the continuous inner surface of the first metal plate;
operably connecting a stud welding gun assembly with a portion of the bar adjacent one of the first or second metal plates;
placing a welding plunge spacer between the stud welding gun assembly and the respective one of the first or second metal plates to set a plunge distance therebetween;
securing the stud welding gun assembly to the bar to prevent relative movement therebetween;
removing the welding plunge spacer;
compressing the stud welding gun assembly towards the respective one of the first or second metal plates to take-up the plunge distance set by the removed welding plunge spacer; and
triggering the stud welding gun assembly to proceed with said step of stud welding the first end of the bar to the continuous inner surface of the first metal plate.

6. The method as set forth in claim 5, wherein the welding plunge spacer defines a slot, and said step of placing the welding plunge spacer between the stud welding gun assembly and the respective one of the first or second metal plates includes disposing the rod within the slot of the welding plunge spacer.

7. The method as set forth in claim 5, further comprising:
wherein said step of operably connecting the stud welding gun assembly to a portion of the bar includes operably connecting a side-gripping stud welding gun assembly to a portion of the bar extending between the first and second plates and adjacent the continuous inner surface of the first metal plate;
wherein said step of placing the welding plunge spacer includes placing the welding plunge spacer between the ferrule and the continuous inner surface of the first metal plate to set the plunge distance;
wherein said step of securing the stud welding gun assembly to the bar includes securing the side-gripping stud welding gun assembly to the bar using at least one side-gripping chuck disposed on the side-gripping stud welding gun assembly to prevent relative movement therebetween;
wherein said step of removing the welding plunge spacer includes removing the welding plunge spacer from between the ferrule and the inner surface of the first metal plate;
wherein said step of compressing the stud welding gun assembly includes compressing the side-gripping stud welding gun assembly towards the inner surface of the first metal plate and into abutting relationship with the ferrule to take up the plunge distance set by the removed welding plunge spacer; and
wherein said step of triggering the stud welding gun assembly includes triggering the side-gripping stud welding gun assembly to proceed with said step of stud welding the first end of the bar to the continuous inner surface of the first metal plate.

8. The method as set forth in claim 7, wherein the insulating member is comprised of an insulating sleeve and said step of arranging an insulating member on the second end of the rod includes disposing the insulating sleeve in surrounding relationship with a portion of the rod disposed adjacent the second end.

9. The method as set forth in claim 5, further comprising
wherein said step of operably connecting the stud welding gun assembly to a portion of the bar includes operably connecting an end-gripping stud welding gun assembly to the second end of the bar protruding outwardly from the outer surface of the second metal plate;
wherein said step of placing the welding plunge spacer includes placing the welding plunge spacer between the end-gripping stud welding gun assembly and the outer surface of the second metal plate to set the plunge distance;
wherein said step of securing the stud welding gun assembly to the bar includes securing a chuck assembly of the end-gripping stud welding gun assembly to the second end of the bar to prevent relative movement therebetween;
wherein said step of removing the welding plunge spacer includes removing the welding plunge spacer from between the end-gripping stud welding gun assembly and the outer surface of the second metal plate;
wherein said step of compressing the stud welding gun assembly includes compressing the end-gripping stud welding gun assembly towards and into abutting relationship with the outer surface of the second metal plate to take up the plunge distance set by the removed welding plunge spacer; and
wherein said step of triggering the stud welding gun assembly includes triggering the end-gripping stud welding gun assembly to proceed with said step of stud welding the first end of the bar to the continuous inner surface of the first metal plate.

10. The method as set forth in claim 9, wherein the insulating member includes an insulating bushing and said step of arranging an insulating member on the second end of the rod includes inserting the insulating bushing through the respective hole in the second metal plate to dispose the insulating bushing on the rod adjacent the second end and in between the rod and the respective hole in the second metal plate.

11. The method as set forth in claim 10, wherein the insulating bushing includes a cylindrical sleeve portion and a flange extending radially outwardly from the sleeve portion, and wherein the step of inserting the insulating bushing through the respective hole in the metal plate includes disposing the cylindrical sleeve portion on the rod and in between the rod and the respective hole in the second metal plate and disposing the flange in abutting and overlaying relationship with the outer upper surface of the second metal plate.

12. The method as set forth in claim 11, wherein the insulating bushing includes an expansion slit extending from the flange and through the cylindrical sleeve portion for allowing the insulating bushing to separate and expand in the radial direction when the insulating bushing is disposed on the rod for accommodating different sized rods having varying diameters.

13. The method as set forth in claim 9, wherein the chuck assembly includes a stationary jaw and a movable jaw pivotably connected to the stationary jaw, and wherein said step of securing the chuck assembly of the end-gripping stud welding gun assembly to the second end of the bar includes seating the second end of the rod in the stationary jaw and pivoting the movable jaw into abutting and clamped relationship with the rod.

14. The method as set forth in claim 13, wherein the stationary jaw defines a concave-shaped cavity for seating the second end of the rod in the stationary jaw.

15. The method as set forth in claim 13, wherein at least one the stationary jaw or the movable jaw includes an electrical isolator for preventing electric flow through the chuck assembly during said stud welding of the first end of the rod to the continuous inner surface of the first metal plate.

16. The method as set forth in claim 5, wherein the rod has a diameter equal to 1″ and the welding plunge spacer has a thickness equal to 5/16″.

17. The method as set forth in claim 5, wherein the rod has a diameter equal to ¾″ an inch and the welding plunge spacer has a thickness equal to ¼″.

18. The method as set forth in claim 5, wherein the rod has a diameter equal to ½″ and the welding spacer has a thickness equal to 3/16″.
